(19) United States
(12) Patent Application Publication
(10) Pub. No.: US 2006/0083662 A1
(43) Pub. Date: Apr. 20, 2006

(54) Pipette tip with side channels for efficient aspiration

(76) Inventor: Maxim V. Myakishev, Rockville, MD (US)

Correspondence Address: CENTRAL COAST PATENT AGENCY, PO BOX 187, AROMAS, CA, 95004, US

(21) Appl. No.: 10/995,634

(22) Filed: Nov. 22, 2004

Related U.S. Application Data
(60) Provisional application No. 60/620,428, filed on Oct. 19, 2004.

(51) Int. Cl. B01L 3/02

(52) U.S. Cl. 422/100

(57) ABSTRACT

An aspirator unit comprises an aspirator having a hollow body around a vertical axis, the body having an outer wall ending at a planar lowermost surface orthogonal to the vertical axis and having a theoretical maximum area, and at least one notch as an indention in the planar bottom surface extending through the outer wall in a direction forming substantially a right angle with the vertical axis. A ratio of area of the actual planar bottom surface with the indention of the notch, to the theoretical maximum bottom surface without a notch is equal or greater than twenty percent.

### FIELD OF THE INVENTION

The present invention is in the area of aspiration and dispensing devices, and pertains more particularly to pipettes and pipette tips.

### BACKGROUND OF THE INVENTION

Pipette devices and disposable pipette tips used with them for the measurement and transfer of liquids are well known in the medical arts. Pipetting is known in laboratory work for manual use in transferring liquid samples, and also for multi-channel micropipettes and robotic liquid handling and pipetting systems. Simultaneous multiple-sample pipetting has allowed researchers to greatly increase productivity. This productivity improvement is especially important in high throughput screening, combinatorial chemistry, pharmaceutical, agricultural and genomic research.

Multichannel pipettes aid liquid aspiration and aliquoting into and out of multiple well plates or tubes. Multiple well plates and multi-channel pipettes have come into wide use in medical, clinical and biotechnology research. The use of plates with 96, 384 wells and tube systems (and greater) is increasing throughout laboratory research.

There are a number of problems associated with multi-channel pipetting. With single channel pipettes, the user has to make sure that only one tip is properly attached to the shaft of the pipette. This simply involves applying sufficient force to have the tip attach and create an air tight seal around the shaft. All of the downward force used to attach the tip is focused on one shaft and one tip. When the user of a multi-channel pipette attaches eight or more tips simultaneously, much greater force must be applied in order to achieve a sufficient seal between all of the shafts and their respective tips. Sometimes the user may employ a rocking motion while inserting the shafts into the tips, and this rocking motion may further assist in seating the tips onto the shaft.

The possibility of an uneven fit of tips on the shafts of a multi-channel pipette can occur. In the event the tips are uneven there may be problems with accurate aspiration or delivery of samples. Other problems may include insufficient time for adequate uptake or dispensing of a sample, problems associated with high viscosity solutions such as bio-polymers, and poor seal between the tip and the shaft of the pipette. Because of these potential problems, the user oftentimes must press the delivery orifice of the tips down onto the bottom of a well in order to pick up or deliver samples accurately. In addition, going all the way to the bottom of the well or vessel is the easiest way to ensure that all of the tips are touching the liquid without having to look at the tips. With small volumes going to the bottom may be the only way to touch and therefore aspirate the liquid.

In many cases the bottom surface of the wells of a multi-well plate are flat. In some cases the bottoms are curved. In the first case the bottoms may be flat because the contents of the plates (wells) are frequently examined under magnification or with other instruments which pass a beam of light from bottom to top, through individual ones of the wells. In order for an analysis of the contents of the well to be accurate, the beam of light must pass through a flat bottom as opposed to a “U” or “V” shaped bottom. Surfaces other than a flat surface cause the diffraction of the light beam and yield poor results.

Further, a significant problem exists with the use of standard pipette tips and flat-bottomed multi-well plates. The delivery orifice of the tip is also typically flat, so when the tip is pressed against the flat bottom of the well, a seal frequently may occur between the two surfaces, or at least the cross-sectional area through which material may be aspirated is drastically reduced. Under these circumstances pipetting of material into or out of the well may become inaccurate or incomplete. This problem also exists with “V” bottom plates, especially with volumes of 0-15 μl.

These problems force the user to not only use the multi-channel pipette in an uncomfortable manner, (holding at difficult angles, moving the tip around within the well, etc.) but also to use extended visual observation of the pipetting to ensure all of the liquid is completely pipetted into or out of the wells. Therefore, in addition to the physical manipulations required to accurately use multi channel pipettes, there is increased mental fatigue as well.

Further to the above, in an operation using multiple tips and multiple wells, the levels of the tips may be uneven, and the levels of the well bottoms may be uneven as well. In such cases, especially if automated, it is necessary to drive the ganged tips down into the wells with considerable force to overcome the effect of unevenness of both wells and tips locations.

In response to these problems a typical procedure with small volumes is to push the tips all the way to the bottom of the well, and then to raise the tips up away from the bottom sufficient for aspiration. Often more than one try is required to achieve satisfactory aspiration. Also, since the distance between the bottom and the top of the material in a well may be measured in millimeters or less, it is very difficult to control the action. This effort repeated many times may further fatigue the user and can cause gross inaccuracy in pipetting.

Accuracy and reproducibility are critical in all pipetting, and are especially critical in small volume multichannel, multi-well work. Therefore a need exists for a device for use on multi-channel pipettes that can accurately and easily pipette liquids into and out of multi-well plates regardless of the well geometry, and that can allow the user to manipulate the multi-channel pipette more easily and with less physical and mental fatigue.

An attempt to solve these problems is illustrated in U.S. Pat. No. 6,482,362 to inventor James C. Smith, issued on Nov. 19, 2002, which is provided in toto in an information disclosure statement filed with this application. In that patent inventor Smith teaches in FIGS. 13-16, and in the last paragraph of column 14 before the claim set, a pipette tip having three narrow feet that cause the tip to stand off from the bottom of a well by the height of the feet. Inventor Smith gives has his rationale for this arrangement “complete aspiration” of material in a well.

In actuality, complete aspiration is not accomplished by this arrangement because the openings between the feet are so extensive as to lose the necessary pressure differential between the inside and the outside of the pipette when level of material in a well falls below the height of the feet. A further serious problem with this arrangement is that the end of a pipette tip is very small, and the material is typically plastic. The considerable pressure needed to be sure all the tips in a multiple-tip array touch the bottom of a well damages the standoff points of all or most of the tips, preventing reliable and accurate aspiration.

What is clearly needed is an improved pipette tip having side channels formed in a manner that allow accurate and complete aspiration without damage to the tips or loss of pressure differential.

### SUMMARY OF THE INVENTION

In a preferred embodiment of the present invention an aspirator unit comprising at least one aspirator having a hollow body around a vertical axis is provided, the body having an outer wall ending at a planar lowermost surface orthogonal to the vertical axis and having a theoretical maximum area, and at least one notch as an indention in the planar bottom surface extending through the outer wall in a direction forming substantially a right angle with the vertical axis. A ratio of area of the actual planar bottom surface with the indention of the notch, to the theoretical maximum bottom surface without a notch, is equal or greater than twenty percent.

In one embodiment the ratio of area is equal to or greater than fifty percent. Also in an embodiment a cross-section of the notch at right angles to the direction of extension is substantially a semicircular arch with rounded bottom corners. Preferably all surface intersections are rounded.

In one embodiment a cross-section of the notch at right angles to the direction of extension is substantially of the shape of a parallelogram, with one side of the parallelogram in the plane of the bottom surface. In another embodiment a cross-section of the notch at right angles to the direction of extension is substantially of the shape of a triangle having a base in the plane of the bottom surface. The notch in this case may meet the bottom surface with rounded edges.

In another embodiment of the invention an aspirator unit is provided wherein two notches as indentions in the bottom surface extend through the outer wall along a line that substantially bisects the bottom surface, dividing the actual planar bottom surface into two regions of substantially equal area, the area of the actual planar bottom surface then being the sum of the areas of the two regions. In a preferred embodiment with the two notches the ratio of area may be equal to or greater than fifty percent.

In one embodiment a cross-section of either notch at right angles to the direction of extension is substantially a semicircular arch with rounded bottom corners. In some embodiments all surface intersections are rounded. Also in some embodiments a cross-section of either notch at right angles to the direction of extension is substantially of the shape of a parallelogram, with one side of the parallelogram in the plane of the bottom surface. In still other embodiments a cross-section of either notch at right angles to the direction of extension may be substantially of the shape of a triangle having a base in the plane of the bottom surface. Preferably the notch meets the bottom surface with rounded edges.

A preferred process for forming aspirator units in the invention is by injection molding. In some cases the aspirator may be enabled as a pipette. In other cases the aspirator may be enabled as a syringe with a positive-displacement element for aspirating and dispensing liquid and semi-liquid material. Also in some cases there may be two or more aspirators molded together, and plastic units may be disposable.

In another aspect of the invention a method for aspirating liquid or semi-liquid material from a well is provided, comprising steps of (a) moving an aspirator unit comprising at least one aspirator having a hollow body around a vertical axis, the body having an outer wall ending at a planar lowermost surface orthogonal to the vertical axis and having a theoretical maximum area, and at least one notch as an indention in the planar bottom surface extending through the outer wall in a direction forming a right angle with the vertical axis such that a ratio of area of the actual planar bottom surface with the indention of the notch, to the theoretical maximum bottom surface without a notch is equal or greater than twenty percent, into the vial until the planar lowermost surface of the pipette engages the substantially flat floor of the well; and (b) creating a positive pressure differential from outside the pipette to inside the pipette, and drawing the material through the notch into the pipette.

In one embodiment of the method the ratio of area is equal to or greater than fifty percent. Also in one embodiment a cross-section of the notch at right angles to the direction of extension is substantially a semicircular arch with rounded bottom corners. Preferably all surface intersections are rounded.

In some cases a cross-section of the notch at right angles to the direction of extension is substantially of the shape of a parallelogram, with one side of the parallelogram in the plane of the bottom surface. In other cases a cross-section of the notch at right angles to the direction of extension may be substantially of the shape of an arch having a base in the plane of the bottom surface. The arch can be substantially a semicircle with rounded bottom edges.

In some embodiments of the method of the invention there may be two notches as indentions in the bottom surface extending through the outer wall along a line that substantially bisects the bottom surface, dividing the actual planar bottom surface into two regions of substantially equal area, the area of the actual planar bottom surface then being the sum of the areas of the two regions. The ratio of area in some embodiments is equal to or greater than fifty percent.

In one embodiment a cross-section of either notch at right angles to the direction of extension is substantially a semicircular arch with rounded bottom corners. Preferably all surface intersections are rounded. In another embodiment a cross-section of either notch at right angles to the direction of extension is substantially of the shape of a parallelogram, with one side of the parallelogram in the plane of the bottom surface. In yet another embodiment a cross-section of either notch at right angles to the direction of extension is substantially of the shape of an arch having a base in the plane of the bottom surface. The arch may be substantially a semicircle.

In many cases the unit may be produced by injection molding. In one embodiment the at least one aspirator is enabled as a pipette for aspirating and dispensing liquid and semi-liquid material. In another embodiment the at least one aspirator may be enabled as a syringe with a positive-displacement element for aspirating and dispensing liquid and semi-liquid material. In some cases there may be two or more aspirators molded together. Also there may be disposable plastic pipettes as aspirators.

### BRIEF DESCRIPTION OF THE DRAWING FIGURES

FIG. 1a is an elevation view of a pipette tip according to an embodiment of the present invention.

FIG. 1b is an enlarged view of the portion of the tip of FIG. 1a represented in the dotted circle 1b.

FIG. 1c is a plan view of the bottom surface of the pipette tip of FIGS. 1a and 1b.

FIG. 1d is an elevation view of the pipette tip of FIGS. 1a, b, and c inserted in a well.

FIG. 1e is a plan view of a pipette tip in an alternative embodiment of the invention.

FIG. 1f is a plan view of a pipette tip in another alternative embodiment.

FIG. 1g is a plan view of a pipette tip in yet another alternative embodiment of the invention.

### DESCRIPTION OF THE PREFERRED EMBODIMENTS

This invention relates to an improvement in disposable pipette tips for single and multi-channel micropipettes and robotic liquid handling and pipetting systems.

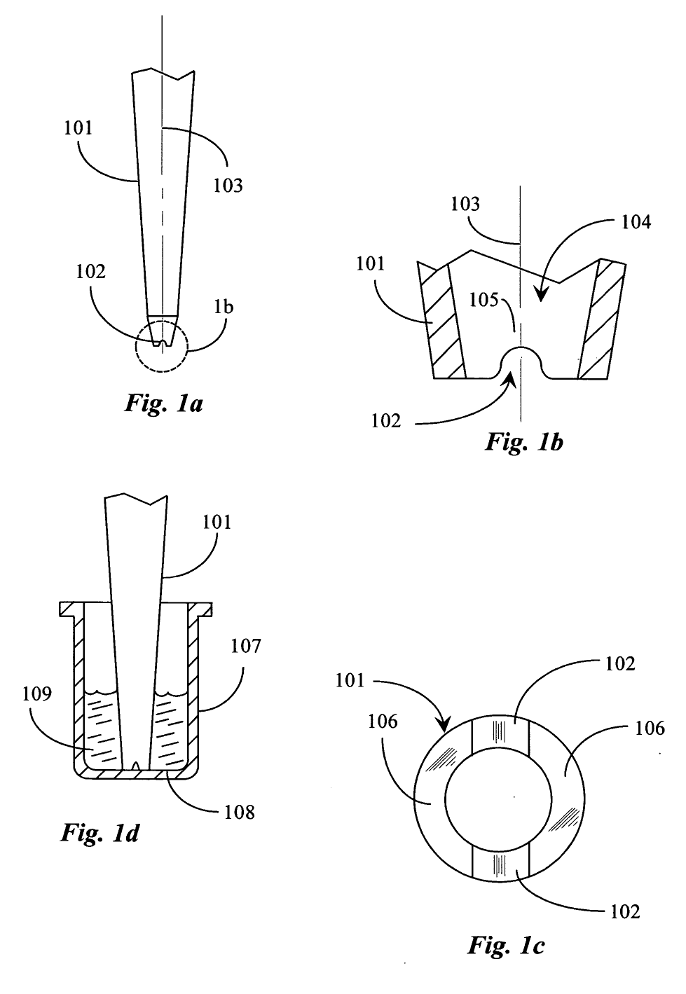

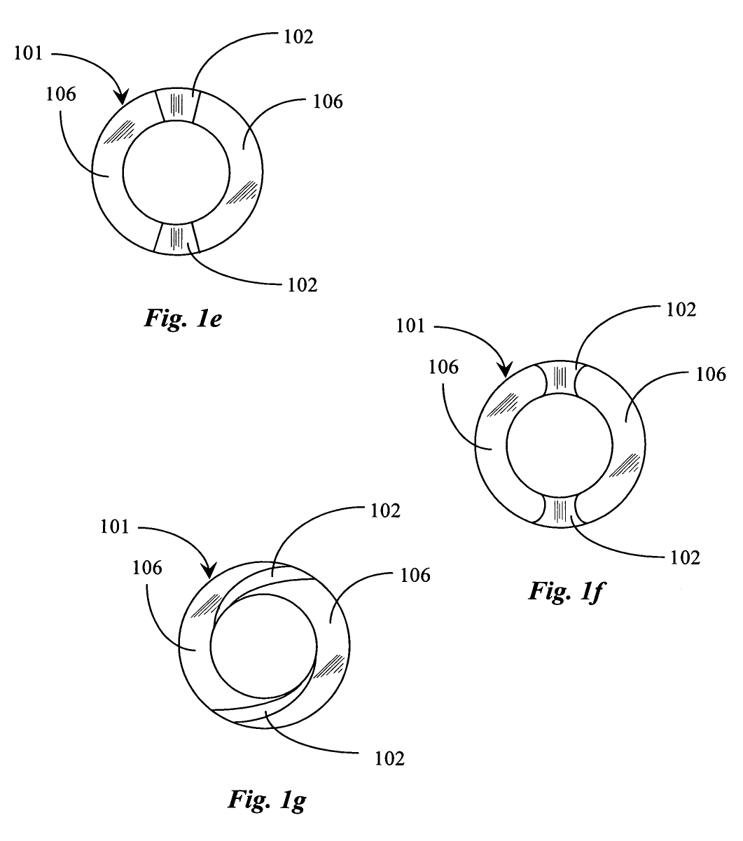

FIGS. 1a through 1d illustrate a pipette tip in various aspects and in use in an embodiment of the present invention. Referring first to FIG. 1a, an elevation view, a pipette tip 101 has a notch shape formed through the outer walls at the lowermost extremity of the tip. As is well-known, pipette tips are tapered constructions that have an inner space (104 FIG. 1b) for material, and narrow to a relatively fine point on the lowermost end. The tip therefore in this example has a circular cross section with a constant wall thickness. Other cross-sections are possible. In the embodiment illustrated the notch shape passes through the outer wall in two places, passing through centerline 103, thus creating two openings 102 from outside the tip to the inside.

FIG. 1b is an enlarged view of the lowermost extremity of pipette tip 101 in section to illustrate additional detail. In FIG. 1b the relative wall thickness may be seen and opening 102 is shown as being arcuate with rounded corners. Smooth, rounded intersections are preferred, but not strictly required in embodiments of the invention. Further, the shape of the opening may vary widely, substantially as a triangle, a square, an inverted U or V shape, circular, trapezoidal, rectangular, conical, ellipsoid or any arc of a circle, for example.

FIG. 1c is a plan view of the lowermost extremity of the pipette tip of FIGS. 1a and 1b in an embodiment of the invention, magnified considerably over the scale of FIG. 1a, and to the scale of FIG. 1b. Tip 101 is seen to have a flat bottom surface in two regions 106, separated by the openings 102. This flat bottom surface is of considerable importance in the invention, as is described more fully below.

FIG. 1d is an elevation view of pipette tip 101 shown urged against flat bottom 108 of a well 107 holding a liquid material 109.

In the Background section above, reference was made to an existing patent relating to pipette tips: in U.S. Pat. No. 6,482,362 to inventor James C. Smith, issued on Nov. 19, 2002. As may be seen in FIGS. 13-16 of this patent, there are three standoff tips 162, which are intended to hold the tip in that invention off the bottom of a well. The present inventors have determined that there are two rather severe problems with this arrangement in the prior art: one being that the tips are prone to quick damage, changing the shape and extent of the areas through which material may be aspirated; and also providing no more than point contact with the well bottom.

The problem of the vulnerable tips is readily apparent, and is particularly troublesome when using a gang arrangement of tips, and with robotic systems, for one reason because the tips may not all be at a same plane, and excessive pressure may have to be applied to seat all the tips. The second problem with the point-contact tips is not so readily apparent, but may be understood quickly by reference to FIGS. 1c and 1d in the present application. FIG. 1c illustrates that in embodiments of the present invention there are at least two broad, flat regions at the lowermost extremity of the unique pipette tip 101, these being regions 106.

Attention is now called to FIG. 1d, which shows a tip 101 urged against a bottom flat surface 108 of a well 107 having material 109 to be aspirated. Relatively broad, flat regions 106 of tip 101 make contact with flat bottom surface 108 of well 107, and a seal is formed. Not only do the broad, flat regions provide considerable support against force used to urge the tip against well bottom 108, but the seal provided ensures a maximum pressure differential from the inside (104) of the tip to the outside, providing for efficient and complete aspiration of material 109.

In tests the present inventors have determined that there may be more than one opening in the lower extremity of a tip in the present invention, and two is preferable, and that the ratio of the total area of the flat bottom regions to the theoretical area of the flat bottom surface if there were no openings is important. The tip in embodiments of the invention works best if the ratio is equal to or greater than 0.5, but advantages are still seen if that ratio falls to as much as 0.2. Below a ratio of 0.2 advantages become more obscure. Therefore, the tip area ratio as defined above should always be above 0.2, and preferably equal to or greater than 0.5. More preferable is a ration of 0.85 to 0.95.

In addition to uses for multichannel pipettes, the notch opening as described for embodiments of the present invention is also useful for single channel pipettes. Further still, in manual operations, although pipettes are calibrated vertically, it is necessary to assume an angle from vertical in aspirating to avoid clogging tips. This “tipping” of tips introduces further error in precision. Notches as taught in various embodiments of the present invention make it possible to perform always in a vertical position, advantageous both for single and dual channel work, and for both manual and robotic operations.

In embodiments of the invention there can be from one to several openings, although two openings is common. The number of openings seems not to affect the “touch off” phenomenon. From the viewpoint of manufacturing pipette tips, which are typically injection molded, more than one opening is a preferred embodiment. A single opening for the tip, which is reflected in the injection mold, can cause an imbalance in the flow of molten plastic between the core pin in the mold, and the mold wall, which makes the hollow of the pipette tip, and the cavity that makes the wall of the pipette tip. This imbalance can cause the tip to have a “banana” shape and can cause flash (residual, unwanted plastic) around the delivery orifice. Flash can dramatically affect accuracy and cause contamination of subsequent samples. By having more than one notch or standoff, the core pin and cavity remain in balance while the plastic is injected into the mold. The problem can also be alleviated by providing for relatively small notches

Although more than one notch opening is preferable, too many can also be a problem, particularly in that the ratio of area of the flat-bottom regions to the total area of the bottom without openings is decreased as the number of openings increases. Further in regard to the shape of the openings at the tip, as was mentioned above, these can be of any one of many shapes, and rounded corners and edges are preferred, although not strictly required. The actual size of openings, related to the width and height of the opening, can vary considerably, and will depend at least to some extent on the nature of the material to be aspirated. A quite viscous material, for example, may require bigger openings; and a thin liquid material may be better aspirated through smaller openings.

There are many alterations that may be made in the embodiments described above without departing materially from the spirit and scope of the invention. FIG. 1e, for example, illustrates a tip geometry wherein the channel openings are tapered in the horizontal plane from smaller inside to greater outside of the pipette body. FIG. 1f illustrates a variation wherein there is a decided curvature to the sidewalls of the notches in the horizontal plane. In FIG. 1g a variation is shown wherein the notches are made in a “swirl” geometry, which is particularly advantageous for delivery of material once aspirated, without splashes.

In addition to the above, tips may be preferably made by injection molding, for example, but this is not a limitation in the invention. Other manufacturing techniques may be used. Also, tips may be made without openings, and openings may be added after tip manufacture by any of a variety of well-known machining techniques. Further, although most tips are injection molded from thermoplastic material, many different plastic formulations may be used, and plastic is not the sole material that may be used. Tips could be made from glass or metal, for example, for very special situations.

Further to the above, tips are in some cases molded separately and then connected together in such as eight- or twelve-tip assemblies. In other cases multiple tips are molded together, such as for 96-well tip assemblies.

Accordingly the invention is to be limited only by the claims that follow:

What is claimed is:

1. An aspirator unit comprising at least one aspirator having a hollow body around a vertical axis, the body having an outer wall ending at a planar lowermost surface orthogonal to the vertical axis and having a theoretical maximum area, and at least one notch as an indention in the planar bottom surface extending through the outer wall in a direction forming substantially a right angle with the vertical axis;
wherein a ratio of area of the actual planar bottom surface with the indention of the notch, to the theoretical maximum bottom surface without a notch, is equal or greater than twenty percent.

2. The aspirator unit of claim 1 wherein the ratio of area is equal to or greater than fifty percent.

3. The aspirator unit of claim 1 wherein a cross-section of the notch at right angles to the direction of extension is substantially a semicircular arch with rounded bottom corners.

4. The aspirator unit of claim 3 wherein all surface intersections are rounded.

5. The aspirator unit of claim 1 wherein a cross-section of the notch at right angles to the direction of extension is substantially of the shape of a parallelogram, with one side of the parallelogram in the plane of the bottom surface.

6. The aspirator unit of claim 1 wherein a cross-section of the notch at right angles to the direction of extension is substantially of the shape of a triangle having a base in the plane of the bottom surface.

7. The aspirator unit of claim 6 wherein the notch meets the bottom surface with rounded edges.

8. The aspirator unit of claim 1 wherein two notches as indentions in the bottom surface extend through the outer wall along a line that substantially bisects the bottom surface, dividing the actual planar bottom surface into two regions of substantially equal area, the area of the actual planar bottom surface then being the sum of the areas of the two regions.

9. The aspirator unit of claim 8 wherein the ratio of area is equal to or greater than fifty percent.

10. The aspirator unit of claim 8 wherein a cross-section of either notch at right angles to the direction of extension is substantially a semicircular arch with rounded bottom corners.

11. The aspirator unit of claim 10 wherein all surface intersections are rounded.

12. The aspirator unit of claim 8 wherein a cross-section of either notch at right angles to the direction of extension is substantially of the shape of a parallelogram, with one side of the parallelogram in the plane of the bottom surface.

13. The aspirator unit of claim 8 wherein a cross-section of either notch at right angles to the direction of extension is substantially of the shape of a triangle having a base in the plane of the bottom surface.

14. The aspirator unit of claim 13 wherein the notch meets the bottom surface with rounded edges.

15. The aspirator unit of claim 1 produced by injection molding.

16. The aspirator unit of claim 1 enabled as a pipette for aspirating and dispensing liquid and semi-liquid material.

17. The aspirator unit of claim 1 enabled as a syringe with a positive-displacement element for aspirating and dispensing liquid and semi-liquid material.

18. The aspirator unit of claim 1 comprising two or more aspirators molded together.

19. The aspirator unit of claim 16 comprising disposable plastic pipettes as aspirators.

20. A method for aspirating liquid or semi-liquid material from a well, comprising steps of:
(a) moving an aspirator unit comprising at least one aspirator having a hollow body around a vertical axis, the body having an outer wall ending at a planar lowermost surface orthogonal to the vertical axis and having a theoretical maximum area, and at least one notch as an indention in the planar bottom surface extending through the outer wall in a direction forming a right angle with the vertical axis such that a ratio of area of the actual planar bottom surface with the indention of the notch, to the theoretical maximum bottom surface without a notch is equal or greater than twenty percent, into the vial until the planar lowermost surface of the pipette engages the substantially flat floor of the well; and
(b) creating a positive pressure differential from outside the pipette to inside the pipette, and drawing the material through the notch into the pipette.

21. The method of claim 20 wherein the ratio of area is equal to or greater than fifty percent.

22. The method of claim 20 wherein a cross-section of the notch at right angles to the direction of extension is substantially a semicircular arch with rounded bottom corners.

23. The method of claim 22 wherein all surface intersections are rounded.

24. The method of claim 20 wherein a cross-section of the notch at right angles to the direction of extension is substantially of the shape of a parallelogram, with one side of the parallelogram in the plane of the bottom surface.

25. The method of claim 20 wherein a cross-section of the notch at right angles to the direction of extension is substantially of the shape of an arch having a base in the plane of the bottom surface.

26. The method of claim 21 wherein the arch is substantially a semicircle with rounded bottom edges.

27. The method of claim 20 wherein two notches as indentions in the bottom surface extend through the outer wall along a line that substantially bisects the bottom surface, dividing the actual planar bottom surface into two regions of substantially equal area, the area of the actual planar bottom surface then being the sum of the areas of the two regions.

28. The method of claim 27 wherein the ratio of area is equal to or greater than fifty percent.

29. The method of claim 27 wherein a cross-section of either notch at right angles to the direction of extension is substantially a semicircular arch with rounded bottom corners.

30. The method of claim 25 wherein all surface intersections are rounded.

31. The method of claim 27 wherein a cross-section of either notch at right angles to the direction of extension is substantially of the shape of a parallelogram, with one side of the parallelogram in the plane of the bottom surface.

32. The method of claim 27 wherein a cross-section of either notch at right angles to the direction of extension is substantially of the shape of an arch having a base in the plane of the bottom surface.

33. The method of claim 32 wherein the arch is substantially a semicircle.

34. The method of claim 16 wherein the pipette is produced by injection molding.

35. The method of claim 20 wherein the at least one aspirator is enabled as a pipette for aspirating and dispensing liquid and semi-liquid material.

36. The method of claim 20 wherein the at least one aspirator is enabled as a syringe with a positive-displacement element for aspirating and dispensing liquid and semi-liquid material.

37. The method of claim 20 wherein the aspirator unit comprises two or more aspirators molded together.

38. The method of claim 34 comprising disposable plastic pipettes as aspirators.
